(19) United States
(12) Patent Application Publication
(10) Pub. No.: US 2026/0338239 A1
(43) Pub. Date: Oct. 29, 2026

(54) ROTATION TRANSMISSION DEVICE

(71) Applicant: NTN CORPORATION, Osaka (JP)

(72) Inventors: Shintarou ISHIKAWA, Shizuoka (JP); Koji SATO, Shizuoka (JP)

(73) Assignee: NTN CORPORATION, Osaka (JP)

(21) Appl. No.: 19/104,904

(22) PCT Filed: Aug. 17, 2023
(86) PCT No.: PCT/JP2023/029735

§ 371 Date: Feb. 19, 2025

(30) Foreign Application Priority Data
Aug. 23, 2022 (JP) 2022-132463

(51) Int. Cl. F16D 27/108; F16D 41/067; F16D 41/08

(52) U.S. Cl. CPC F16D 27/108; F16D 41/067; F16D 41/08

(57) ABSTRACT

A rotation transmission device is provided which includes a roller cage supported to be circumferentially movable between the outer periphery of an inner ring and the inner periphery of an outer ring; an armature axially opposed to an electromagnet so as to axially move when the electromagnet is energized; and a motion converting mechanism for circumferentially moving the roller cage according to axial movement of the armature. The electromagnet has an inner diameter dimension larger than the outer diameter dimension of the outer ring, and the electromagnet is disposed radially outward of the outer ring so as to surround the outer periphery of the outer ring.

### TECHNICAL FIELD

The present invention relates to a rotation transmission device used to selectively allow and prevent transmission of rotation.

### BACKGROUND ART

For example, a rotation transmission device as disclosed in the below-identified Patent Document 1 is known as a rotation transmission device that switches an engaged state in which rotation is transmitted between an inner ring and an outer ring to an idling state in which rotation is not transmitted between the inner ring and the outer ring, or that switches the idling state to the engaged state.

In the rotation transmission device of Patent Document 1, a roller clutch part and an electromagnetic clutch part are axially arranged next to each other. The roller clutch part includes an outer ring; an inner ring disposed radially inward of the outer ring; rollers disposed between the inner periphery of the outer ring and the outer periphery of the inner ring; and a roller cage supported to be circumferentially movable between an engagement position where the rollers are engaged with the inner periphery of the outer ring and the outer periphery of the inner ring and a disengagement position where the rollers are disengaged from the inner periphery of the outer ring and the outer periphery of the inner ring. The electromagnetic clutch part includes an annular electromagnet; an armature axially opposed to the electromagnet so as to axially move when the electromagnet is energized; and a motion converting mechanism for circumferentially moving the roller cage of the roller clutch part from the disengagement position to the engagement position according to axial movement of the armature.

When the electromagnet is energized, the rotation transmission device of Patent Document 1 goes into an engaged state in which the rollers are engaged with the outer periphery of the inner ring and the inner periphery of the outer ring such that rotation is transmitted between the inner ring and the outer ring. On the other hand, when the electromagnet is de-energized, the rotation transmission device goes into an idling state in which the rollers are disengaged from the outer periphery of the inner ring and the inner periphery of the outer ring such that rotation is not transmitted between the inner ring and the outer ring.

### PRIOR ART DOCUMENT(S)

### Patent Documents(s)

Patent Document 1: Japanese Unexamined Patent Application Publication No. 2003-90356

### SUMMARY OF THE INVENTION

### Problems to be Solved by the Invention

The rotation transmission device of Patent Document 1 has an advantage in that since torque is transmitted by allowing the rollers (engagement elements) to engage with the outer periphery of the inner ring and the inner periphery of the outer ring, large torque is transmissible. However, since the roller clutch part and the electromagnetic clutch part are axially arranged next to each other, the rotation transmission device has a long axial dimension, and requires an axially long installation space.

It is an object of the present invention to provide a rotation transmission device which can reduce the axial installation space required.

### Means for Solving the Problems

In order to achieve the above object, the present invention provides a rotation transmission device having the following arrangement:

### [Arrangement 1]

A rotation transmission device comprising:
an outer ring;
an inner ring disposed radially inward of the outer ring, and supported to be rotatable relative to the outer ring;
engagement elements disposed between an inner periphery of the outer ring and an outer periphery of the inner ring;
an engagement element cage supported to be circumferentially movable between an engagement position where the engagement elements are engaged with the inner periphery of the outer ring and the outer periphery of the inner ring and a disengagement position where the engagement elements are disengaged from the inner periphery of the outer ring and the outer periphery of the inner ring;
an annular electromagnet;
an armature axially opposed to the electromagnet so as to axially move when the electromagnet is energized; and
a motion converting mechanism configured to circumferentially move the engagement element cage from one of the engagement position and the disengagement position to the other position according to axial movement of the armature,
characterized in that the electromagnet has an inner diameter dimension larger than an outer diameter dimension of the outer ring, and the electromagnet is disposed radially outward of the outer ring so as to surround an outer periphery of the outer ring.

With this arrangement, since the electromagnet has an inner diameter dimension larger than the outer diameter dimension of the outer ring, and the electromagnet is disposed radially outward of the outer ring so as to surround the outer periphery of the outer ring, compared to an arrangement where the electromagnet and the outer ring are axially arranged next to each other so as not to overlap with each other when radially seen, due to the overlap of the electromagnet and the outer ring when radially seen, it is possible to reduce the axial length of the rotation transmission device, and thus reduce the axial installation space required to install the rotation transmission device.

### [Arrangement 2]

The rotation transmission device according to arrangement 1, further comprising switch springs elastically retaining the engagement element cage at the disengagement position,
wherein the engagement element cage is a tubular member having pockets in which the respective engagement elements are received, and
wherein the switch springs comprise:
a first switch spring engaged in a first spring engagement portion formed in a portion of the engagement element cage located on one axial side of the pockets; and
a second switch spring engaged in a second spring engagement portion formed in a portion of the engagement element cage located on the other axial side of the pockets.

With this arrangement, since the switch springs for elastically retaining the engagement element cage at the disengagement position are constituted by a plurality of springs (first and second switch springs), the engagement element cage can be retained at the disengagement position by a large spring force. Therefore, when the inner ring accelerates or decelerates with a large acceleration or deceleration with the engagement element cage located at a disengagement position where the engagement elements are disengaged from the outer periphery of the inner ring and the inner periphery of the outer ring, it is possible to prevent circumferential movement of the engagement element cage relative to the inner ring due to the acceleration or deceleration of the inner ring. Therefore, it is possible to prevent the engagement elements from engaging erroneously with the outer periphery of the inner ring and the inner periphery of the outer ring.

### [Arrangement 3]

The rotation transmission device according to arrangement 2, wherein the first spring engagement portion and the second spring engagement portion are disposed 180 degrees opposite to each other when axially seen.

With this arrangement, since the spring force of the first switch spring and the spring force of the second switch spring act on the engagement element cage at positions 180 degrees opposite to each other when axially seen, it is possible to prevent the center axis of the engagement element cage from being displaced from the center axis of the inner ring, and thus to stabilize the behavior of the engagement element cage.

### [Arrangement 4]

The rotation transmission device according to any one of arrangements 1 to 3, further comprising a separation spring biasing the armature in an axial direction away from the electromagnet,
wherein the armature is rotationally fixed to the engagement element cage so as to rotate in unison with the engagement element cage, and
wherein one axial end of the separation spring is in abutment with the armature, and the other axial end of the separation spring is supported by a spring receiving member disposed to rotate in unison with the inner ring.

With this arrangement, since the separation spring is supported by the spring receiving member, which rotates in unison with the inner ring, it is possible to prevent wear of the separation spring due to rotational sliding in an idling state, and ensure sufficient durability even when the device is used in a high-speed rotation environment.

### [Arrangement 5]

The rotation transmission device according to arrangement 4, further comprising an annular rotor fixed to the outer ring so as to rotate in unison with the outer ring, and disposed between the armature and the electromagnet,
wherein the spring receiving member is disposed radially inward of the rotor.

With this arrangement, since the spring receiving member is disposed radially inward of the rotor, the rotation transmission device has a reduced size.

### [Arrangement 6]

The rotation transmission device according to any one of arrangements 1 to 5, wherein the electromagnet and the outer ring are disposed on a same axial side relative to the armature.

### EFFECTS OF THE INVENTION

With respect to the rotation transmission device of the present invention, since the electromagnet has an inner diameter dimension larger than the outer diameter dimension of the outer ring, and the electromagnet is disposed radially outward of the outer ring so as to surround the outer periphery of the outer ring, compared to an arrangement where the electromagnet and the outer ring are axially arranged next to each other so as not to overlap with each other when radially seen, due to the overlap of the electromagnet and the outer ring when radially seen, it is possible to reduce the axial length of the rotation transmission device, and thus reduce the axial installation space required to install the rotation transmission device.

### BRIEF DESCRIPTION OF THE DRAWINGS

FIG. 1 is a sectional view of a rotation transmission device according to an embodiment of the present invention.

FIG. 2 is a right-side view of FIG. 1.

FIG. 3 is an enlarged sectional view illustrating a roller clutch part of the rotation transmission device of FIG. 1 and the vicinity thereof.

FIG. 4 is a sectional view taken along line IV-IV of FIG. 3.

FIG. 5 is a sectional view taken along line V-V of FIG. 3.

FIG. 6 is an exploded perspective view illustrating a roller cage of FIG. 3 and the vicinity thereof.

FIG. 7 is a view schematically illustrating, as an example, a driving device in which the rotation transmission device of FIG. 1 is used.

### BEST MODE FOR CARRYING OUT THE INVENTION

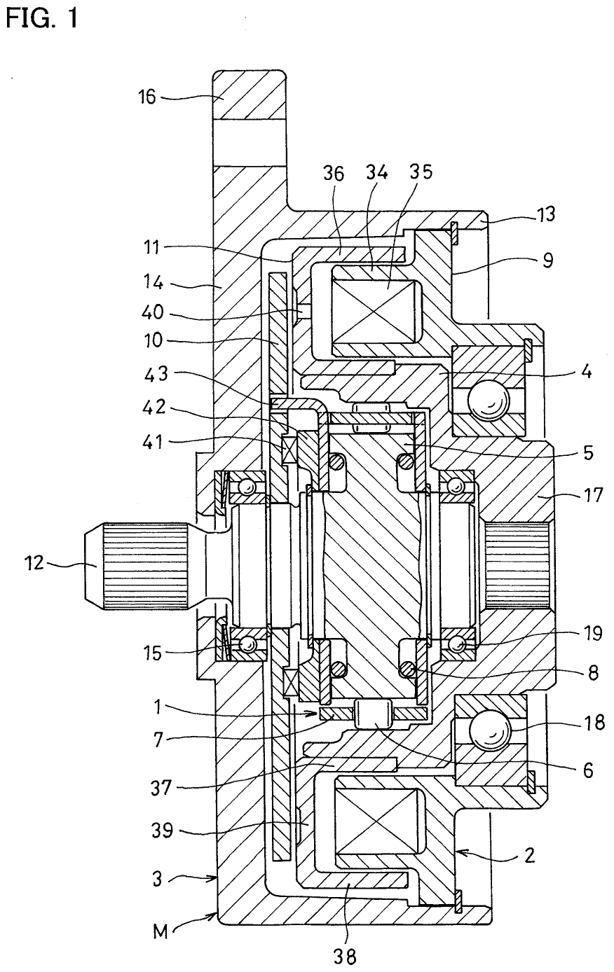

FIG. 1 illustrates a rotation transmission device M according to an embodiment of the present invention. This rotation transmission device M includes a roller clutch part 1; an electromagnetic clutch part 2 for switching one of an engaged state and an idling state of the roller clutch part 1 to the other state; and a housing 3 in which the roller clutch part 1 and the electromagnetic clutch part 2 are received.

The roller clutch part 1 includes an outer ring 4; an inner ring 5 disposed radially inward of the outer ring 4; rollers 6 disposed between the inner periphery of the outer ring 4 and the outer periphery of the inner ring 5; a roller cage 7 supported to be circumferentially movable between an engagement position where the rollers 6 are engaged with the inner periphery of the outer ring 4 and the outer periphery of the inner ring 5 and a disengagement position where the rollers 6 are disengaged from the inner periphery of the outer ring 4 and the outer periphery of the inner ring 5; and switch springs 8 elastically retaining the roller cage 7 at the disengagement position. On the other hand, the electromagnetic clutch part 2 includes an annular electromagnet 9 disposed radially outward of the outer ring 4; an armature 10 axially opposed to the electromagnet 9 so as to axially move when the electromagnet 9 is energized; and a motion converting mechanism 11 for circumferentially moving the roller cage 7 according to axial movement of the armature 10.

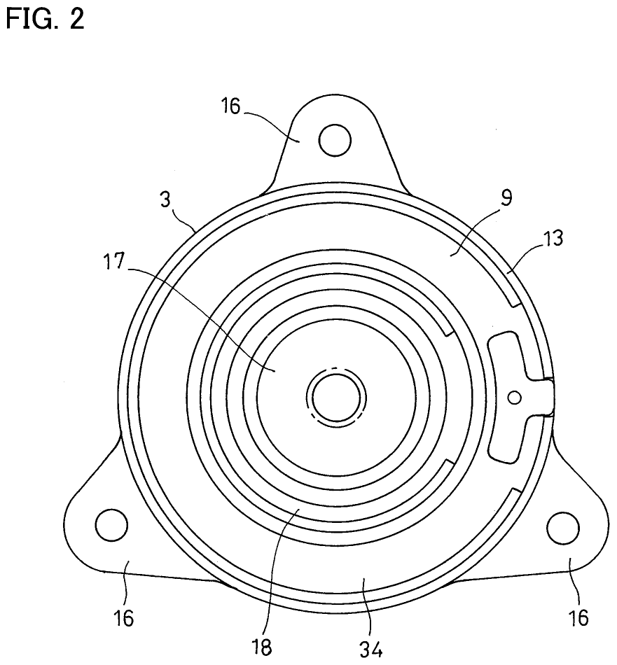

The inner ring 5 is integrally formed with an input shaft 12. The input shaft 12 may be a separate member provided separately from the inner ring 5, and coupled to the inner ring 5 by serration fitting or the like such that the inner ring 5 and the input shaft 12 rotate in unison with each other. The housing 3 includes a tubular portion 13 disposed to surround the radially outer side of the electromagnet 9; and an inward extending flange portion 14 extending radially inward from one axial end of the tubular portion 13. An input-side bearing 15 rotatably supporting the input shaft 12 is disposed on the inner periphery of the inward extending flange portion 14. The housing 3 further includes a plurality of attachment pieces 16 (see FIG. 2) extending radially outward from the one axial end of the tubular portion 13.

The outer ring 4 is integrally formed with an output shaft 17. The output shaft 17 may be a separate member provided separately from the outer ring 4, and coupled to the outer ring 4 by serration fitting or the like such that the outer ring 4 and the output shaft 17 rotate in unison with each other. The output shaft 17 is rotatably supported by an output-side bearing 18 disposed on the inner periphery of the electromagnet 9. An intermediate bearing 19 supporting the inner ring 5 such that the inner ring 5 is rotatable relative to the outer ring 4 is disposed on the inner periphery of the outer ring 4. The input shaft 12, the inner ring 5, the outer ring 4, and the output shaft 17 are all coaxially arranged.

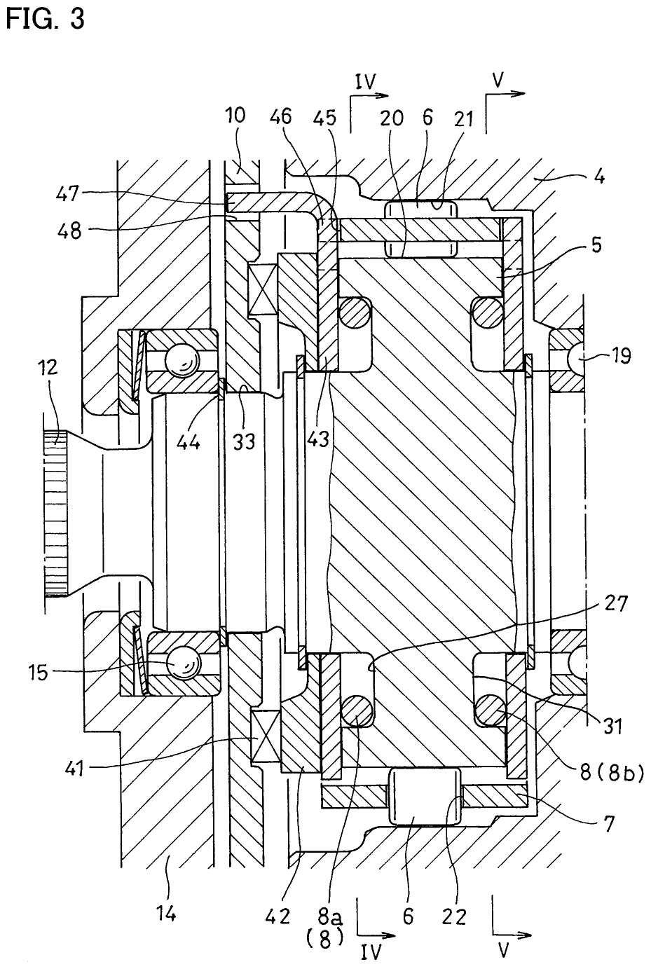

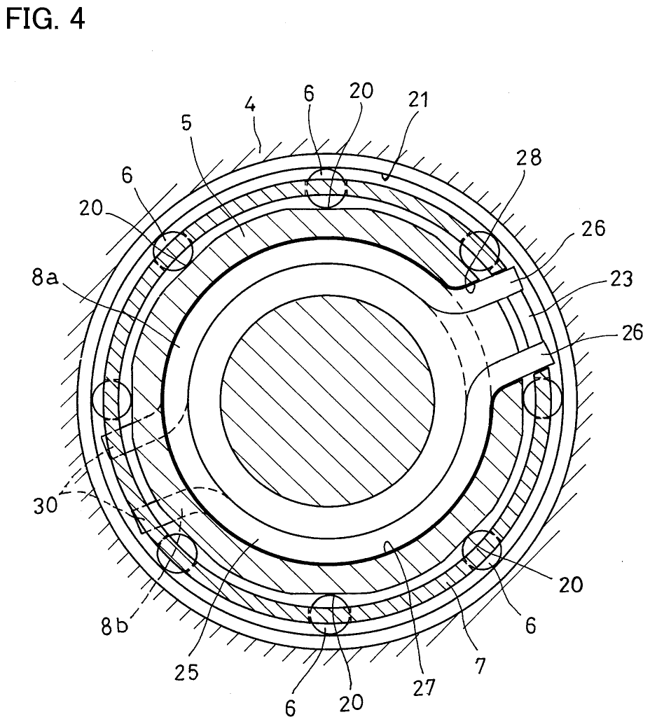

As illustrated in FIGS. 3 and 4, the inner ring 5 has, on its outer periphery, a plurality of cam surfaces 20 circumferentially equidistantly spaced apart from each other. The outer ring 4 has, on its inner periphery, a cylindrical surface 21 radially opposed to the cam surfaces 20. The cam surfaces 20 and the cylindrical surface 21 define wedge-shaped spaces each gradually narrowing from the circumferential center thereof toward both circumferential ends thereof, and the cam surfaces 20 are, e.g., flat surfaces radially opposed to the cylindrical surface 21. As illustrated in FIG. 4, a respective one of the rollers 6 is disposed between each cam surface 20 and the cylindrical surface 21.

The roller cage 7 is a tubular member having a plurality of pockets 22 (see FIG. 3) that radially extend through the cylindrical member, and that are circumferentially spaced apart from each other. The rollers 6 are received in the respective pockets 22. The roller cage 7 is supported to be circumferentially movable relative to the inner ring 5, between an engagement position where by circumferentially moving the rollers 6 from the circumferential central positions of the respective cam surfaces 20, the rollers 6 are engaged with the respective cam surfaces 20 and the cylindrical surface 21 and a disengagement position where by moving the rollers 6 to the circumferential central positions of the respective cam surfaces 20, the rollers 6 are disengaged from the respective cam surfaces 20 and the cylindrical surface 21.

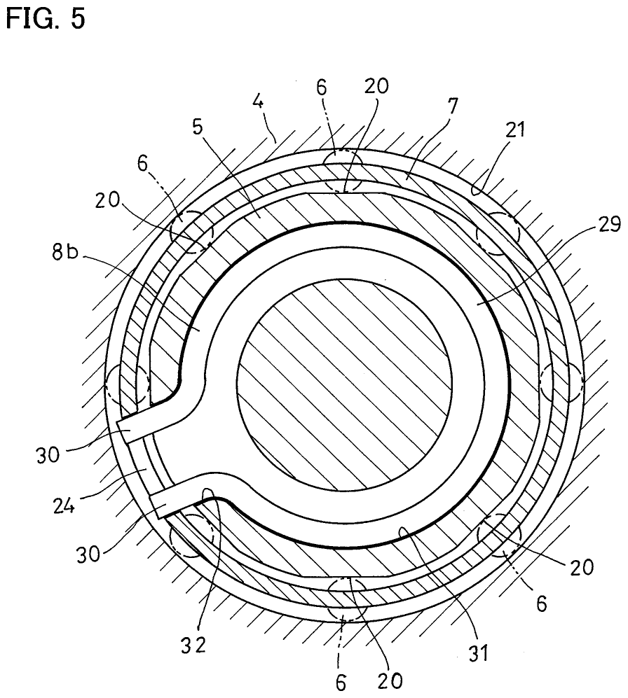

As illustrated in FIG. 3, the switch springs 8 comprise a first switch spring 8a engaged in a first spring engagement portion 23 (see FIG. 4) formed in a portion of the roller cage 7 located on one axial side (left side in FIG. 3) of the pockets 22; and a second switch spring 8b engaged in a second spring engagement portion 24 (see FIG. 5) formed in a portion of the roller cage 7 located on the other axial side (right side in FIG. 3) of the pockets 22.

As illustrated in FIG. 4, the first switch spring 8a comprises a C-shaped annular portion 25 formed by winding a steel wire into a C-shape; and a pair of extending portions 26 extending radially outward from both ends of the C-shaped annular portion 25, respectively. The C-shaped annular portion 25 is fitted in a circular first spring receiving recess 27 formed in the end surface of the inner ring 5 on one axial side. The extending portions 26 are inserted in a first radial groove 28 formed in the end surface of the inner ring 5 on the one axial side so as to extend radially outward through the inner ring 5 from the first spring receiving recess 27.

The extending portions 26 of the first switch spring 8a protrude beyond the radially outer end of the first radial groove 28, and the portions of the extending portions 26 protruding beyond the first radial groove 28 are engaged in the first spring engagement portion 23, which is formed in one axial end of the roller cage 7. The first spring engagement portion 23 is a recess having the same circumferential width as the first radial groove 28. The extending portions 26 of the first switch spring 8a are in contact with the inner surface of the first radial groove 28 and the inner surface of the first spring engagement portion 23, and the roller cage 7 is elastically retained at the disengagement position by the circumferential forces acting on the contact portions. That is, when the roller cage 7 is circumferentially displaced from the disengagement position shown in FIG. 4 relative to the inner ring 5, and is moved to the engagement position, the roller cage 7 is biased, by the elastic restoring force of the first switch spring 8a, in the direction in which the roller cage 7 returns to the disengagement position.

As illustrated in FIG. 5, as with the first switch spring 8a, the second switch spring 8b also comprises a C-shaped annular portion 29 formed by winding a steel wire into a C-shape; and a pair of extending portions 30 extending radially outward from both ends of the C-shaped annular portion 29, respectively. The C-shaped annular portion 29 is fitted in a circular second spring receiving recess 31 formed in the end surface of the inner ring 5 on the other axial side. The extending portions 30 are inserted in a second radial groove 32 formed in the end surface of the inner ring 5 on the other axial side so as to extend radially outward through the inner ring 5 from the second spring receiving recess 31.

The extending portions 30 of the second switch spring 8b protrude beyond the radially outer end of the second radial groove 32, and the portions of the extending portions 30 protruding beyond the second radial groove 32 are engaged in the second spring engagement portion 24, which is formed in the other axial end of the roller cage 7. The second spring engagement portion 24 is a recess having the same circumferential width as the second radial groove 32. The extending portions 30 of the second switch spring 8b are in contact with the inner surface of the second radial groove. 32 and the inner surface of the second spring engagement portion 24, and the roller cage 7 is elastically retained at the disengagement position by the circumferential forces acting on the contact portions. That is, when the roller cage 7 is circumferentially displaced from the disengagement position shown in FIG. 5 relative to the inner ring 5, and is moved to the engagement position, the roller cage 7 is biased, by the elastic restoring force of the second switch spring 8b, in the direction in which the roller cage 7 returns to the disengagement position.

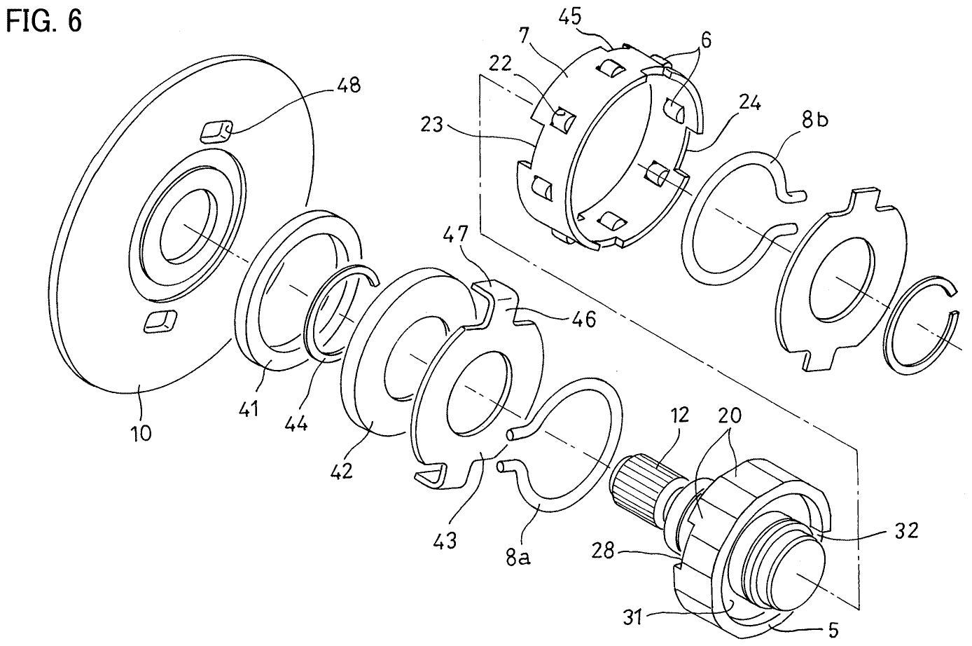

As illustrated in FIGS. 4 and 6, the first spring engagement portion 23 and the second spring engagement portion 24 of the roller cage 7 are located 180 degrees opposite to each other when axially seen. Due to this, the circumferential position of the portion where a spring force acts on the roller cage 7 from the first switch spring 8a and the circumferential position of the portion where a spring force acts on the roller cage 7 from the second switch spring 8b are located opposite to each other such that the center of the roller cage 7 is located therebetween when axially seen.

As illustrated in FIG. 3, the armature 10 is supported by a cylindrical surface 33 of the input shaft 12 on its outer periphery so as to be rotatable and axially movable relative to the inner ring 5. The armature 10 is a disk-shaped member formed of a magnetic material (such as iron or silicon steel). The armature 10 is axially opposed to the inward extending flange portion 14. The electromagnet 9 (see FIG. 1) and the outer ring 4 are disposed on the same axial side relative to the armature 10 (on the side of the armature 10 opposite from the side thereof opposed to the inward extending flange portion 14, or on the right side in FIG. 1).

As illustrated in FIG. 1, the electromagnet 9 includes an annular field core 34 formed of a magnetic material; and a solenoid coil 35 wound around the field core 34. The field core 34 has a C-shaped cross section axially opening toward the armature 10. The field core 34 is fixedly fitted to the inner periphery of the tubular portion 13 of the housing 3. The electromagnet 9 has an inner diameter dimension larger than the outer diameter dimension of the outer ring 4, and is disposed radially outward of the outer ring 4 so as to surround the outer periphery of the outer ring 4.

An annular rotor 36 is disposed between the armature 10 and the electromagnet 9. The rotor 36 includes an inner tubular portion 37 opposed to the radially inner side of the electromagnet 9; an outer tubular portion 38 opposed to the radially outer side of the electromagnet 9; and a circular annular plate portion 39 extending to pass between the axially opposed surfaces of the armature 10 and the electromagnet 9, and to couple the inner tubular portion 37 and the outer tubular portion 38 to each other. The inner tubular portion 37 is fitted with interference to the outer periphery of the outer ring 4. Due to the fitting of the inner tubular portion 37, the rotor 36 is fixed to the outer ring 4 so as to rotate in unison with the outer ring 4. The inner tubular portion 37, the outer tubular portion 38, and the circular annular plate portion 39 of the rotor 36 are integrally formed of a magnetic material (such as iron or silicon steel). The circular annular plate portion 39 of the rotor 36 is formed with a plurality of through holes 40 axially extending through the circular annular plate portion 39, and circumferentially spaced apart from each other. The through holes 40 have an elongated shape circumferentially elongated in the circular annular plate portion 39 of the rotor 36.

When the electromagnet 9 (solenoid coil 35) is energized, a magnetic circuit is formed to pass through the field core 34, the rotor 36 and the armature 10, so that the armature 10 axially moves toward the field core 34, and is attracted to the circular annular plate portion 39 of the rotor 36.

As illustrated in FIG. 1, a separation spring 41 is disposed radially inward of the rotor 36 so as to bias the armature 10 in the axial direction away from the electromagnet 9 (to the left side in FIG. 1). The separation spring 41 is an annular spring member arranged coaxially with the input shaft 12, and is disposed in an axially compressed state between the armature 10 and a spring receiving member 42. As the separation spring 41, it is possible to use, e.g., a wave washer, a disc spring, a compression coil spring or the like. One axial end of the separation spring 41 in abutment with the side surface of the armature 10 opposed to the electromagnet 9 (right side in FIG. 1), and the other axial end of the separation spring 41 is supported by the spring receiving member 42.

As illustrated in FIG. 3, the spring receiving member 42 is pressed against an intermediate plate 43 (described later) by the axial reaction force received from the separation spring 41. In an idling state, due to the frictional force acting between the spring receiving member 42 and the intermediate plate 43, the spring receiving member 42 rotates in unison with the inner ring 5. While an example was described where the separation spring 41 is supported by the spring receiving member 42, which is formed separately from the intermediate plate 43, the spring receiving member 42 and the intermediate plate 43 may be formed as an integral member.

As illustrated in FIG. 3, the movement of the armature 10 in the axial direction away from the electromagnet 9 (to the left side in FIG. 3) is restricted by a snap ring 44 mounted on the outer periphery of the input shaft 12. Also, the armature 10 is pressed against the snap ring 44 by the spring force of the separation spring 41.

As illustrated in FIG. 1, the motion converting mechanism 11 includes a rotor 36 disposed between the armature 10 and the electromagnet 9, and rotationally fixed to the outer ring 4 so as to rotate in unison with the outer ring 4; and an intermediate plate 43 rotationally fixed to the roller cage 7, and rotationally fixed to the armature 10 so as to be axially movable relative to the armature 10.

As illustrated in FIGS. 3 and 6, the intermediate plate 43 has, on its outer periphery, engagement protrusions 46 engaged in respective engagement recesses 45 formed in the one axial end of the roller cage 7. The intermediate plate 43 is rotationally fixed to the roller cage 7 by the engagement of the engagement protrusions 46 in the respective engagement recesses 45 so as to circumferentially move in unison with the roller cage 7.

Aso, the intermediate plate 43 has axial protrusions 47 axially extending toward the armature 10. The armature 10 has axial holes 48 in which the respective axial protrusions 47 of the intermediate plate 43 are axially slidably inserted. By the engagement of the axial protrusions 47 in the respective axial holes 48, the intermediate plate 43 is rotationally fixed to the armature 10 so as to circumferentially move in unison with the armature 10 with the armature 10 axially movable relative to the intermediate plate 43. The armature 10 is rotationally fixed to the roller cage 7 via the intermediate plate 43, and rotates in unison with the roller cage 7.

The motion converting mechanism 11 is configured such that when the armature 10 shown in FIG. 1 moves in the axial direction toward the electromagnet 9 until the armature 10 comes into contact with the rotor 36, due to the difference in rotational speed and the frictional force acting between the armature 10 and the rotor 36, the armature 10 rotates relative to the inner ring 5, and the roller cage 7, which is rotationally fixed to the armature 10 via the intermediate plate 43, also rotates relative to the inner ring 5, so that the roller cage 7 circumferentially moves from the disengagement position to the engagement position against the spring forces of the first switch spring 8a and the second switch spring 8b.

An example of the operation of the rotation transmission device M is now described.

While the electromagnet 9 shown in FIG. 1 is not energized, the rotation transmission device M is in a disengaged state (idling state) in which in the inner ring 5 is rotatable freely relative to the outer ring 4. That is, while the electromagnet 9 is not energized, the armature 10 is separated from the rotor 36 by the spring force of the separation spring 41, and thus the armature 10 is rotatable freely relative to the rotor 36. At this time, since the roller cage 7 is retained at the disengagement position by the switch springs 8, even when the inner ring 5 is rotated, the rollers 6 do not engage with the cam surfaces 20 of the inner ring 5 on the outer periphery thereof and the cylindrical surface 21 of the outer ring 4 on the inner periphery thereof that are shown in FIGS. 3 to 5, and thus the rotation transmission device M is in an idling state in which rotation is not transmitted between the inner ring 5 and the outer ring 4.

On the other hand, while the electromagnet 9 shown in FIG. 1 is energized, the rotation transmission device M is in an engaged state in which rotation is transmitted between the inner ring 5 and the outer ring 4. That is, when the electromagnet 9 is energized, the armature 10 is attracted to the rotor 36, and the armature 10 is kept in frictional contact with the rotor 36. At this time, when the inner ring 5 is rotated, since the armature 10 in frictional contact with the electromagnet 9 is rotationally fixed to the roller cage 7 via the intermediate plate 43, rotation of the roller cage 7 is restricted, and the inner ring 5 rotates relative to the roller cage 7. As a result, the roller cage 7 moves from the disengagement position to the engagement position against the spring forces of the switch springs 8, and the rollers 6 engage with the cam surfaces 20 of the inner ring 5 on the outer periphery thereof and the cylindrical surface 21 of the outer ring 4 on the inner periphery thereof that are shown in FIGS. 3 to 5, so that the rotation transmission device M is in an engaged state in which rotation is transmitted between the inner ring 5 and the outer ring 4.

In the rotation transmission device M, as illustrated in FIG. 1, the electromagnet 9 has an inner diameter dimension larger than the outer diameter dimension of the outer ring 4, and the electromagnet 9 is disposed radially outward of the outer ring 4 so as to surround the outer periphery of the outer ring 4. Therefore, compared to an arrangement where the electromagnet 9 and the outer ring 4 are axially arranged next to each other so as not to overlap with each other when radially seen, due to the overlap of the electromagnet 9 and the outer ring 4 when radially seen, it is possible to reduce the axial length of the rotation transmission device M, and thus reduce the axial installation space required to install the rotation transmission device M.

Also, in the rotation transmission device M, since the switch springs 8 for elastically retaining the roller cage 7 at the disengagement position are constituted by a plurality of springs (first and second switch springs 8a and 8b) as illustrated in FIG. 3, the roller cage 7 can be retained at the disengagement position by a large spring force. Therefore, when the inner ring 5 accelerates or decelerates with a large acceleration or deceleration with the roller cage 7 located at a disengagement position where the rollers 6 are disengaged from the outer periphery of the inner ring 5 and the inner periphery of the outer ring 4, it is possible to prevent circumferential movement of the roller cage 7 relative to the inner ring 5 due to the acceleration or deceleration of the inner ring 5. Therefore, even when the device is used in a high-speed rotation environment, it is possible to prevent the rollers 6 from engaging erroneously with the outer periphery of the inner ring 5 and the inner periphery of the outer ring 4. Thus, the device is suitable for use in a high-speed rotation environment.

Also, in the rotation transmission device M, since, as illustrated in FIG. 4, the spring force of the first switch spring 8a and the spring force of the second switch spring 8b act on the roller cage 7 at positions 180 degrees opposite to each other when axially seen, it is possible to prevent the center axis of the roller cage 7 from being displaced from the center axis of the inner ring 5, and thus to stabilize the behavior of the roller cage 7.

Also, in the rotation transmission device M, since the separation spring 41 is supported by the spring receiving member 42, which rotates in unison with the inner ring 5 in an idling state, it is possible to prevent wear of the separation spring 41 due to rotational sliding in the idling state, and ensure sufficient durability even when the device is used in a high-speed rotation environment.

Also, since the spring receiving member 42 is disposed radially inward of the rotor 36, the rotation transmission device M has a reduced size.

While, in the above embodiment, an example was described in which the rollers 6 are disposed as engagement elements between the inner periphery of the outer ring 4 and the outer periphery of the inner ring 5, the present invention is also similarly applicable to a rotation transmission device in which balls or sprags are used as engagement elements.

Also, in the above embodiment, as the motion converting mechanism 11, a motion converting mechanism is used which moves the roller cage 7 from the disengagement position to the engagement position by axial movement of the armature 10 in the direction toward the electromagnet 9 (i.e., a normal operation type of rotation transmission device M is used which is in the disengaged state while the electromagnet is not energized, and which is in the engaged state while the electromagnet is energized). However, as the motion converting mechanism 11, a motion converting mechanism may be used which moves the roller cage 7 from the engagement position to the disengagement position by axial movement of the armature 10 in the direction toward the electromagnet 9 (i.e., a reverse operation type of rotation transmission device M may be used which is in the engaged state while the electromagnet is not energized, and which is in the disengaged state while the electromagnet is energized). In this case, as the switch springs 8, switch springs are used which elastically retain the roller cage 7 (not at the disengagement position but) at the engagement position.

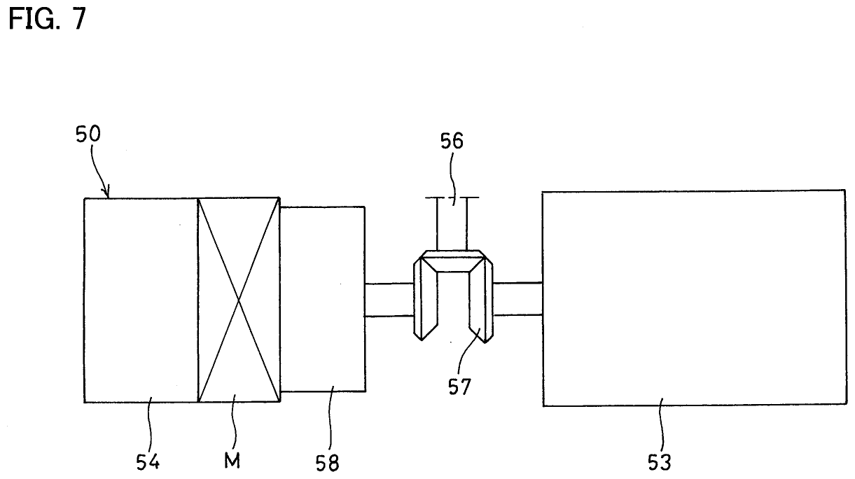

FIG. 7 illustrates, as an example, a driving device 50 in which the rotation transmission device M of the above embodiment is used. The driving device 50 is a hybrid driving device including an engine 53 and an electric motor 54.

The driving device 50 includes an engine 53, a shaft 56, a bevel gear device 57 coupling the engine 53 and the shaft 56 together, and an electric motor 54 disposed to be orthogonal to the shaft 56. The rotation transmission device M and a speed reducer 58 are disposed between the electric motor 54 and the shaft 56.

For example, the present invention is applicable to a mechanism in which, for example, as illustrated in FIG. 7, the rotation transmission device M is disposed between the electric motor 54 and the speed reducer 58, the engine 53, which is a prime mover having output higher than that of the electric motor 54, is disposed on the output side of the speed reducer 58, and one of a driving mode in which the electric motor 54 is a driving source and a driving mode in which the engine 53 is a driving source is switched to the other mode. The engine 53 may be replaced with a different type of prime mover having output higher than that of the electric motor 54. The electric motor 54 is connected to the input shaft 12 (see FIG. 1) of the rotation transmission device M, and the speed reducer 58 is connected to the output shaft 17 (see FIG. 1) of the rotation transmission device M. By energizing the electromagnet 9 of the rotation transmission device M shown in FIG. 1 such that the rotation transmission device M is in an engaged state in which rotation is transmitted between the inner ring 5 and the outer ring 4, rotation of the electric motor 54 shown in FIG. 7 can be transmitted to the shaft 56 through the rotation transmission device M and the speed reducer 58 (motor drive mode). On the other hand, when the shaft 56 is rotationally driven by the power of the engine 53 shown in FIG. 7, the electromagnet 9 of the rotation transmission device M shown in FIG. 1 is de-energized such that the rotation transmission device M is in an idling state (engine drive mode).

Since, while the shaft 56 is driven by only the engine 53, the electric motor 54 is stopped, the input shaft 12 (see FIG. 1) of the rotation transmission device M connected to the electric motor 54 does not rotate, whereas the output shaft 17 (see FIG. 1) of the rotation transmission device M rotates at a high speed due to the rotation transmitted from the engine 53.

That is, in the drive device 50, the rotation transmission device M is disposed at a location where high-speed differential rotation occurs during idling. However, as described above, even if the rotation transmission device M of this embodiment is used at a location where high-speed rotation occurs during idling, it is possible to effectively prevent wear of the separation spring 41 shown in FIG. 1 due to rotational sliding, and prevent the rollers 6 from engaging erroneously with the outer periphery of the inner ring 5 and the inner periphery of the outer ring 4. Thus, the rotation transmission device M is suitable for power transmission switching in a mechanism where the output side idles while rotating at a high speed as in the driving device 50 shown in FIG. 7.

The above-described embodiment is a mere example in every respect, and the present invention is not limited thereto. The scope of the present invention is indicated not by the above description but by the claims, and should be understood to include all modifications within the meaning and scope equivalent to the scope of the claims.

### DESCRIPTION OF REFERENCE NUMERALS

4: Outer ring
5: Inner ring
6: Roller (engagement element)
7: Roller cage (engagement element cage)
8: Switch spring
8a: First switch spring
8b: Second switch spring
9: Electromagnet
10: Armature
11: Motion converting mechanism
22: Pocket
23: First spring engagement portion
24: Second spring engagement portion
36: Rotor
41: Separation spring
42: Spring receiving member
M: Rotation transmission device

1. A rotation transmission device comprising:
an outer ring;
an inner ring disposed radially inward of the outer ring and supported to be rotatable relative to the outer ring;
engagement elements disposed between an inner periphery of the outer ring and an outer periphery of the inner ring;
an engagement element cage supported to be circumferentially movable between an engagement position where the engagement elements are engaged with the inner periphery of the outer ring and the outer periphery of the inner ring and a disengagement position where the engagement elements are disengaged from the inner periphery of the outer ring and the outer periphery of the inner ring;
an annular electromagnet;
an armature axially opposed to the electromagnet so as to axially move when the electromagnet is energized; and
a motion converting mechanism configured to circumferentially move the engagement element cage from one of the engagement position and the disengagement position to the other position according to axial movement of the armature,
wherein the electromagnet has an inner diameter dimension larger than an outer diameter dimension of the outer ring and the electromagnet is disposed radially outward of the outer ring so as to surround an outer periphery of the outer ring.

2. The rotation transmission device according to claim 1, further comprising switch springs elastically retaining the engagement element cage at the disengagement position,
wherein the engagement element cage is a tubular member having pockets in which the respective engagement elements are received, and
wherein the switch springs comprise:
a first switch spring engaged in a first spring engagement portion formed in a portion of the engagement element cage located on one axial side of the pockets; and
a second switch spring engaged in a second spring engagement portion formed in a portion of the engagement element cage located on the other axial side of the pockets.

3. The rotation transmission device according to claim 2, wherein the first spring engagement portion and the second spring engagement portion are disposed 180 degrees opposite to each other when axially seen.

4. The rotation transmission device according to claim 1, further comprising a separation spring biasing the armature in an axial direction away from the electromagnet,
wherein the armature is rotationally fixed to the engagement element cage so as to rotate in unison with the engagement element cage, and
wherein one axial end of the separation spring is in abutment with the armature, and the other axial end of the separation spring is supported by a spring receiving member disposed to rotate in unison with the inner ring.

5. The rotation transmission device according to claim 4, further comprising an annular rotor fixed to the outer ring so as to rotate in unison with the outer ring, and disposed between the armature and the electromagnet,
wherein the spring receiving member is disposed radially inward of the rotor.

6. The rotation transmission device according to claim 1, wherein the electromagnet and the outer ring are disposed on a same axial side relative to the armature.

7. The rotation transmission device according to claim 2, further comprising a separation spring biasing the armature in an axial direction away from the electromagnet,
wherein the armature is rotationally fixed to the engagement element cage so as to rotate in unison with the engagement element cage, and
wherein one axial end of the separation spring is in abutment with the armature, and the other axial end of the separation spring is supported by a spring receiving member disposed to rotate in unison with the inner ring.

8. The rotation transmission device according to claim 3, further comprising a separation spring biasing the armature in an axial direction away from the electromagnet,
wherein the armature is rotationally fixed to the engagement element cage so as to rotate in unison with the engagement element cage, and
wherein one axial end of the separation spring is in abutment with the armature, and the other axial end of the separation spring is supported by a spring receiving member disposed to rotate in unison with the inner ring.

9. The rotation transmission device according to claim 2, wherein the electromagnet and the outer ring are disposed on a same axial side relative to the armature.

10. The rotation transmission device according to claim 3, wherein the electromagnet and the outer ring are disposed on a same axial side relative to the armature.

11. The rotation transmission device according to claim 4, wherein the electromagnet and the outer ring are disposed on a same axial side relative to the armature.

12. The rotation transmission device according to claim 5, wherein the electromagnet and the outer ring are disposed on a same axial side relative to the armature.

13. The rotation transmission device according to claim 7, wherein the electromagnet and the outer ring are disposed on a same axial side relative to the armature.

14. The rotation transmission device according to claim 8, wherein the electromagnet and the outer ring are disposed on a same axial side relative to the armature.
